(19) United States
(12) Patent Application Publication
(10) Pub. No.: US 2014/0166675 A1
(43) Pub. Date: Jun. 19, 2014

(54) SPHERICAL OBJECT FORMED OF SEVERAL JOINT PARTS

(71) Applicant: Juha Ari Niemi, (US)

(72) Inventor: Pertti Niemi, Helsinki (FI)

(73) Assignee: Juha Ari Niemi, Helsinki (FI)

(21) Appl. No.: 14/232,152

(22) PCT Filed: Jun. 20, 2012
(86) PCT No.: PCT/FI2012/050643

§ 371 Date: Feb. 21, 2014

(30) Foreign Application Priority Data
Jul. 13, 2011 (FI) 20115751

(51) Int. Cl. F17C 3/08; F17C 3/02

(52) U.S. Cl. CPC F17C 3/08; F17C 3/025
USPC 220/592.26; 220/592.27

(57) ABSTRACT

A spherical object formed of several joint parts, including at least twenty hexagonal panel-type elements and at least twelve pentagonal panel-type elements. Each panel-type element has a radius of curvature such that when joined together, they form a hollow spherical object, the radius of curvature of which is at least 0.75 metres. The panel-type elements are provided with an attachment and handling cap. Around the spherical object are fixed first vacuum components that form an inner vacuum layer, and second vacuum components that form an outer vacuum layer at a distance from the inner vacuum layer in the radial direction of the spherical object. Between the inner vacuum layer and outer vacuum layer are arranged intermediate components forming an intermediate layer. The vacuum components and intermediate components further include fixing means by which they can be fixed in place to the attachment and handling caps.

The present invention relates to a spherical object formed of several joint parts, the parts of the spherical object comprising at least twenty pieces of hexagonal panel-type elements and at least twelve pieces of pentagonal panel-type elements, and the radius of curvature of each panel-type element is formed to be such that when joined together, they form a hollow spherical object, the radius of curvature of which is at least 0.75 metres, and each panel-type element is provided with an attachment and handling cap.

Previously are known spherical or ball-shaped objects made of several parts for various purposes, the manufacture of which objects from several parts is appropriate due to their large size and/or manufacturing technique. As an example can be mentioned a spherical container made of metal plates known from patent application no. FI 20105520. This type of spherical containers can be used, for example, in ocean-going vessels as liquid gas (for example natural gas) shipping tanks or storage tanks. Such containers are typically about 10-40 metres in outer diameter, which facilitates the fabrication of the containers disclosed in patent application no. FI 20105520 from small joint parts, which include 20 pieces of hexagonal and 12 pieces of pentagonal panels, in terms of production engineering.

However, currently such containers, especially containers intended for transporting liquid gas (LNG containers) are provided with an insulating layer. The insulating layer is formed of insulating material, such as polyurethane, attached to the surface of the container or in its vicinity in the radial direction. However, in order to obtain sufficient insulation with the above-mentioned material, the overall thickness of the construction from the inner surface of the container walls to the outer surface of the insulation becomes relatively high. Providing this type of a thick insulating layer around the spherical object is, however, relatively expensive. Costs increase further when thermal expansion of the construction is taken into account, which is necessary with the prior art spherical containers. The structure then becomes complex or as container material have to be used alloys, such as steel alloys, with low thermal expansion, which are expensive compared to ordinary metals. Furthermore, attaching the insulation pieces to the spherical object is currently quite difficult because due to the shape of the spherical container, the prior art insulation components are relatively multiform, which means that their installation requires precision. The insulation components forming the insulation layer of the prior art spherical objects do not have ready-made fixing means or points by means of which the insulation components could be attached directly to the spherical container.

The aim of the present invention is to provide a spherical object by means of which the foregoing disadvantages are avoided. In other words, the aim of the present invention is to provide a spherical object around which are structurally novel components which make possible a thinner and cost-wise more economical insulation layer than before. A further aim of the invention is to provide structurally novel insulation for the spherical object, which is also easy and simple to fix in place compared to the prior art.

The above-mentioned aim of the invention is achieved in accordance with the present invention in such a way that around the spherical object are fixed vacuum components, which include first vacuum components that form an inner vacuum layer, and second vacuum components that form an outer vacuum layer, which is at a distance from the inner vacuum layer in the radial direction of the spherical object, that between the inner vacuum layer and outer vacuum layer are arranged intermediate components which form an intermediate layer, and that the vacuum components and intermediate components comprise fixing means by means of which the vacuum components and the intermediate components can be fixed in place to the attachment and handling caps. By means of the present invention, the disadvantages of the prior art described above can be eliminated, or at least substantially reduced, especially as regards large spherical objects made of metal plates. As advantages may be mentioned saving in insulation material and fast and simple fixing of the insulation components. Furthermore, the layered construction can be made flexible. In this way is avoided the use of expensive materials with a low thermal expansion coefficient. The shape of the vacuum components and intermediate components can be selected to correspond to the shape of each hexagonal or pentagonal panel-type element in the spherical object, which is extremely advantageous in view of the manufacture and fixing of the vacuum components and intermediate components.

Preferred embodiments of the present invention are disclosed in the dependent claims.

The present invention is described in greater detail in the following, with reference to the accompanying drawings, in which:

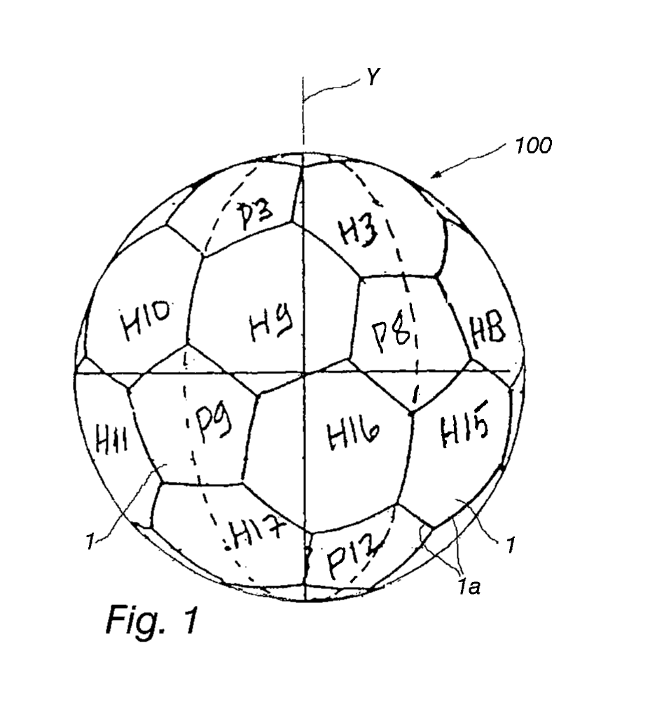

FIG. 1 shows the spherical object of the invention, which is formed of panel-type elements welded together,

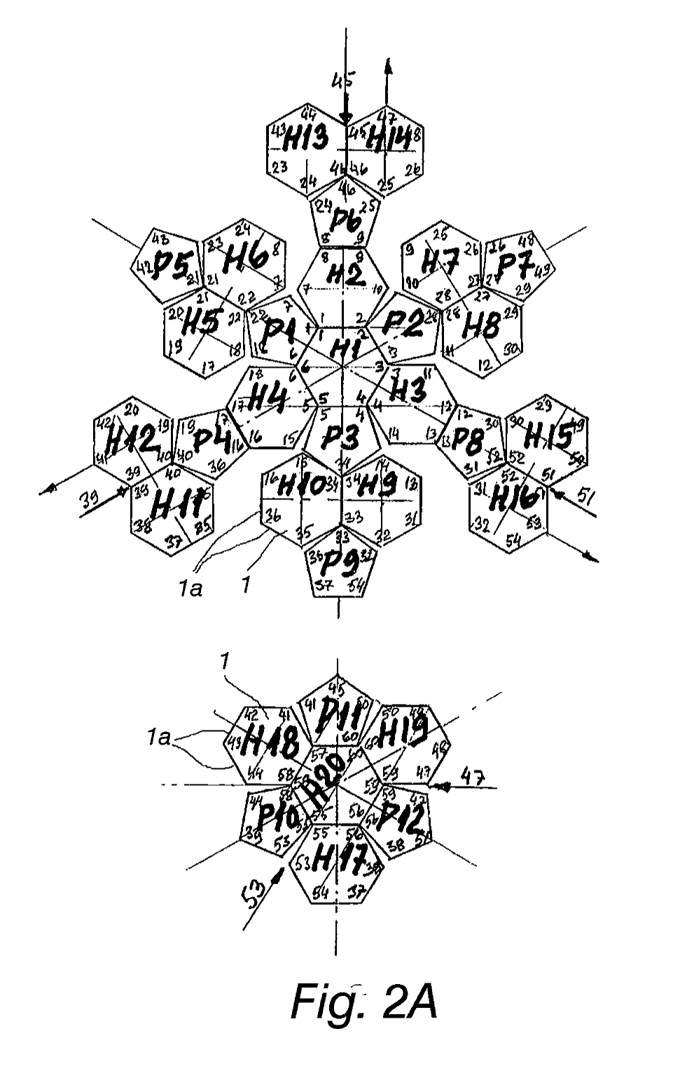

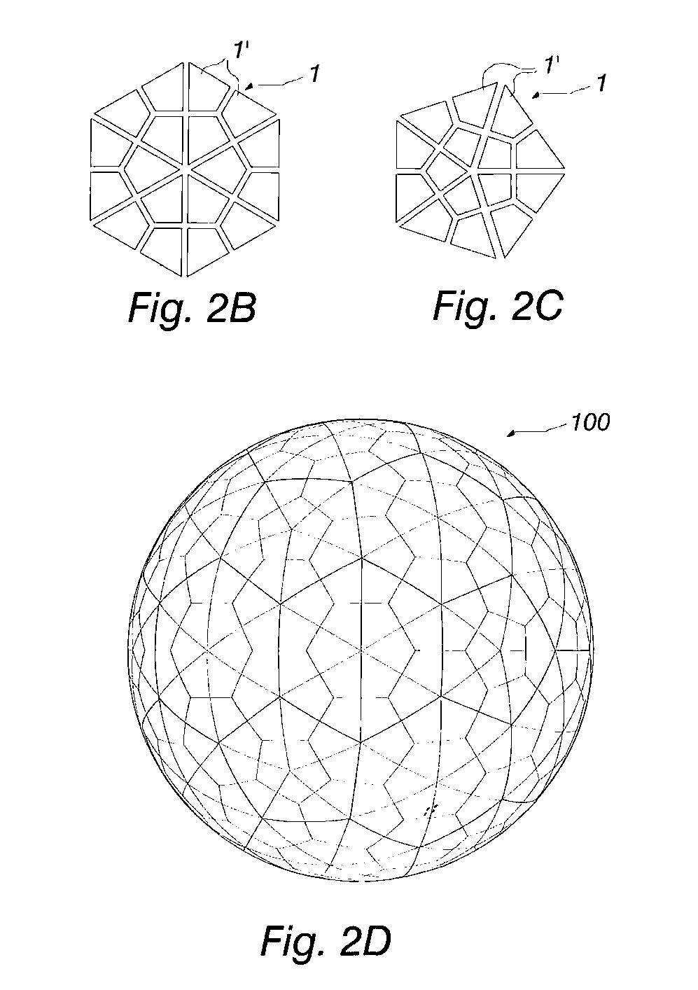

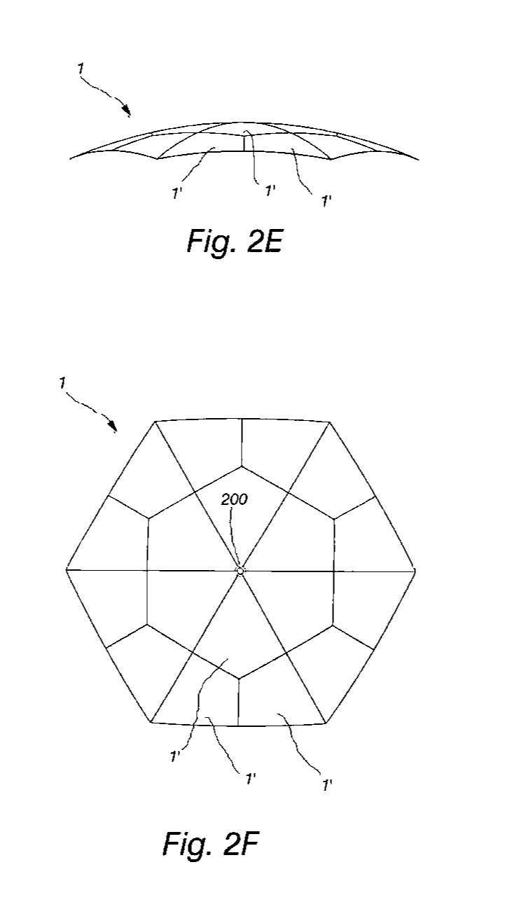

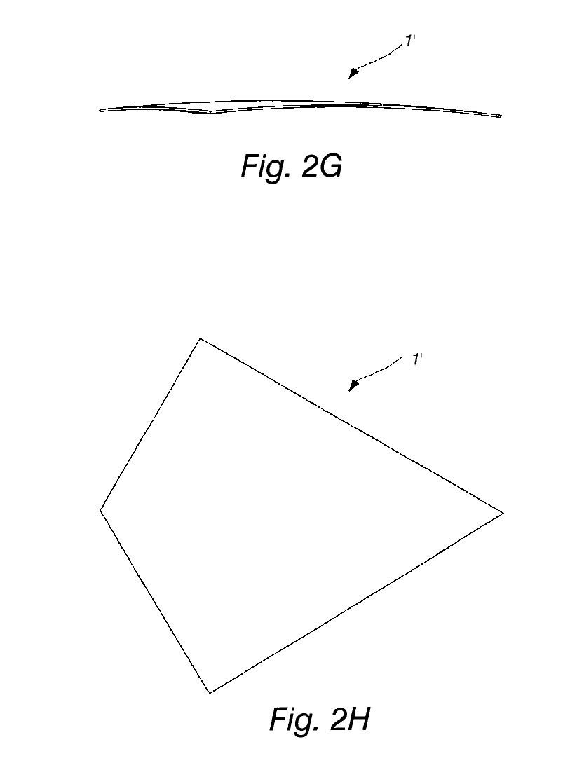

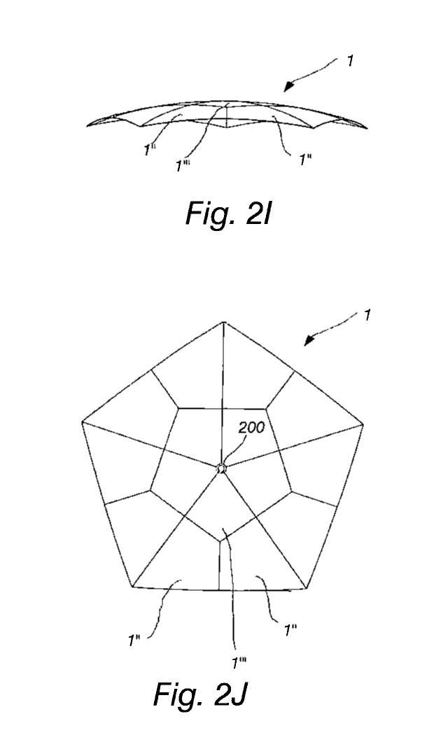

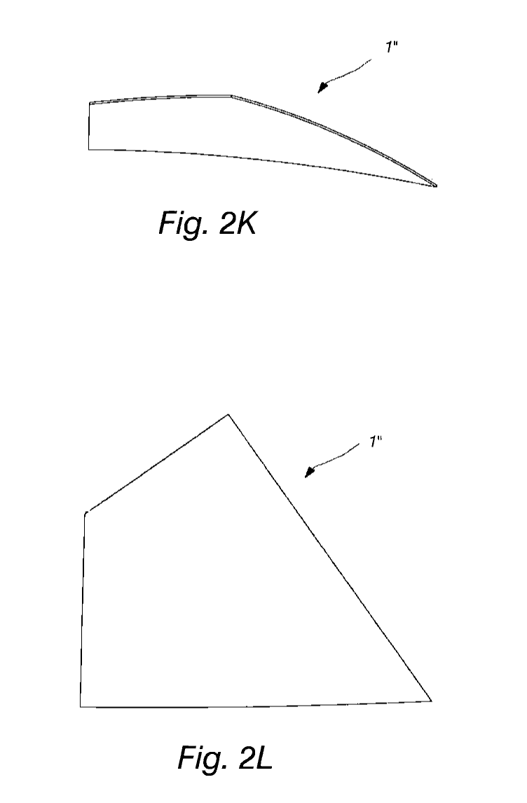

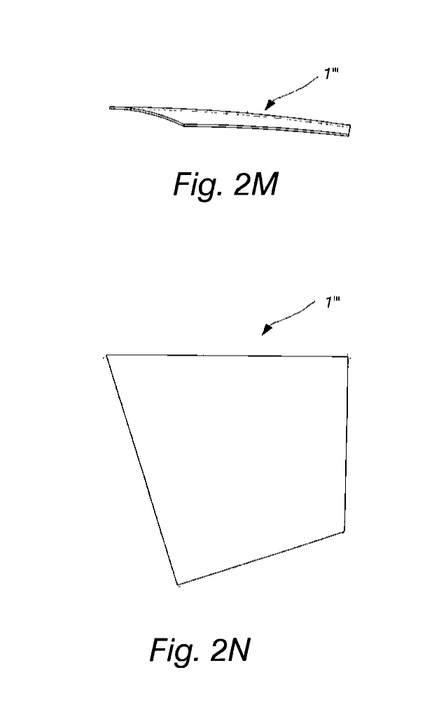

FIG. 2A shows the panel-type elements and their relative locations in a plan view,

FIGS. 2B and 2C show panel-type elements or, similarly, a steel plate formed of segments,

FIG. 2D shows a spherical object formed of the panel-type elements and steel plates shown in FIGS. 2B and 2C,

FIGS. 2E-2N show in greater detail the panel-type elements shown in FIGS. 2B and 2C and their segments,

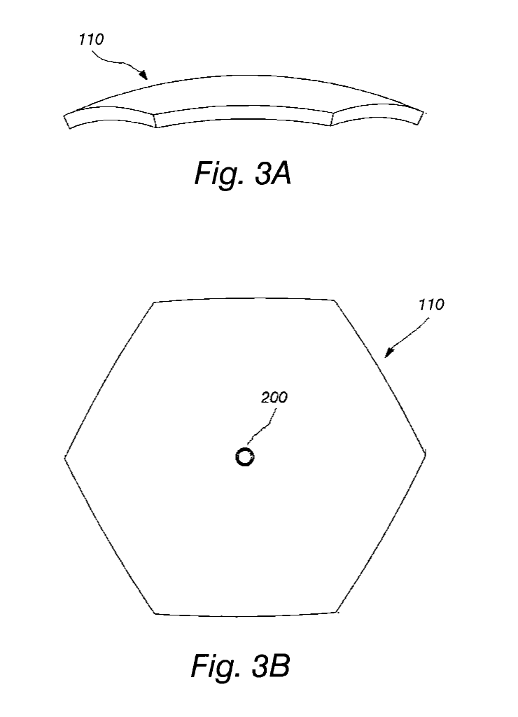

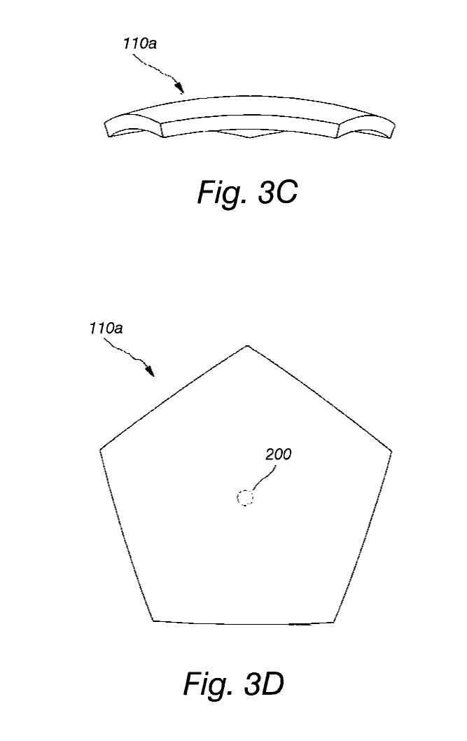

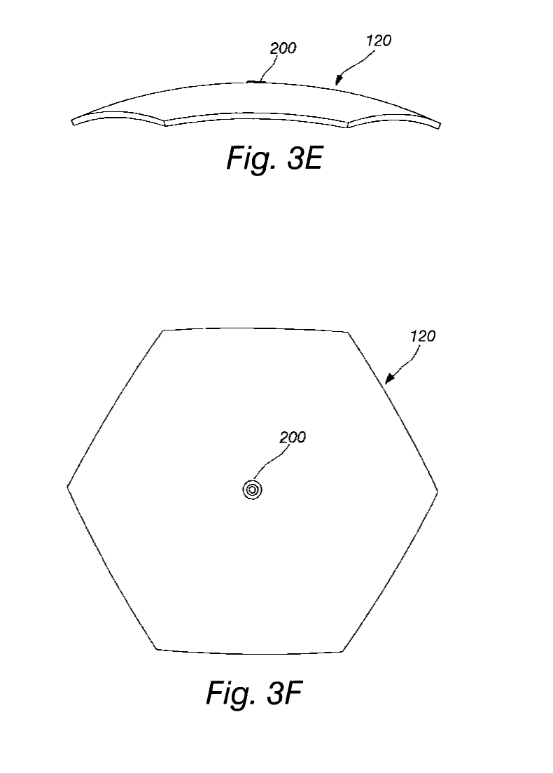

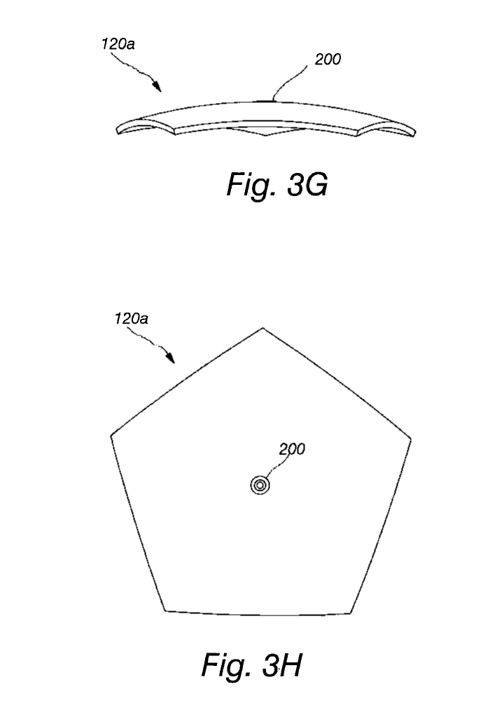

FIG. 3A shows a side view of a hexagonal first vacuum component according to one embodiment,

FIG. 3B shows a top view of the vacuum component of FIG. 3A,

FIG. 3C shows a side view of a pentagonal first vacuum component according to one embodiment,

FIG. 3D shows a top view of the vacuum component of FIG. 3C,

FIG. 3E shows a side view of a hexagonal second vacuum component according to one embodiment,

FIG. 3F shows a top view of the vacuum component of FIG. 3E,

FIG. 3G shows a side view of a pentagonal second vacuum component according to one embodiment,

FIG. 3H shows a top view of the vacuum component of FIG. 3G,

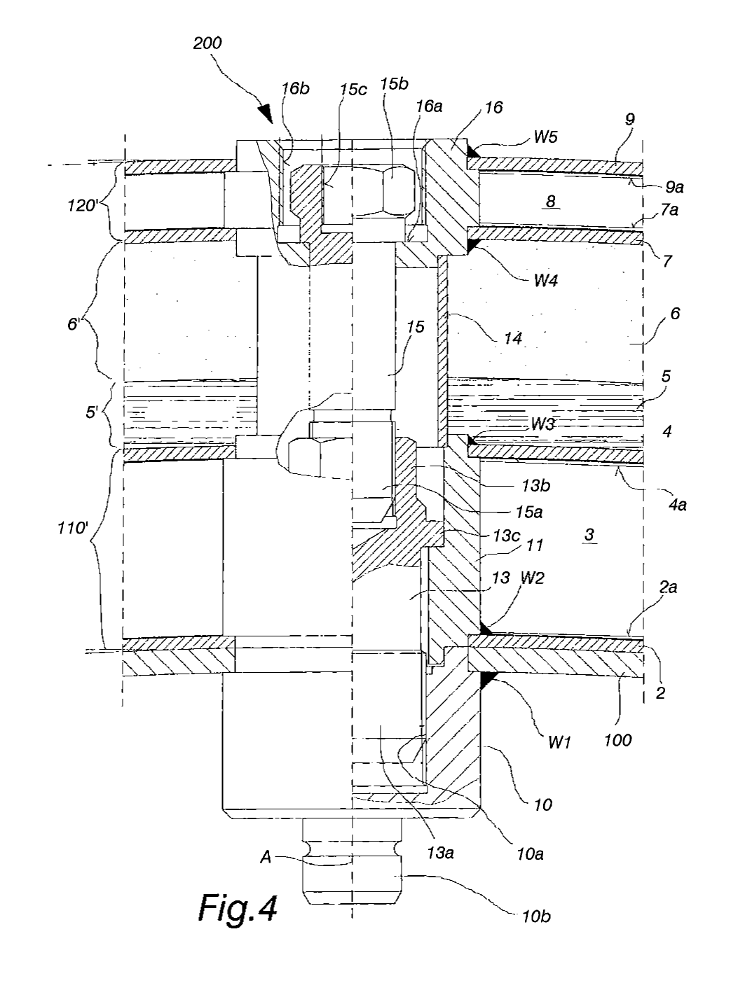

FIG. 4 shows a cross-sectional view of an attachment and handling cap comprised in the panel-type element and the insulation components connected to it by the fixing means,

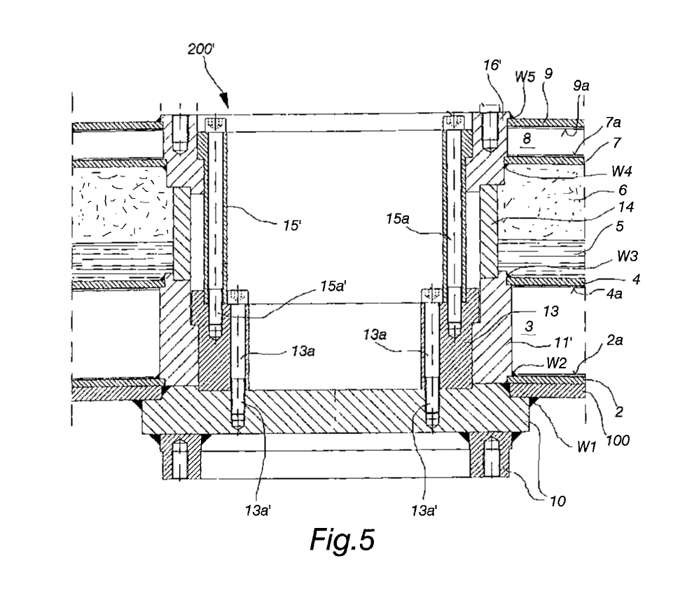

FIG. 5 shows a cross-sectional view of an attachment and handling cap comprised in a panel-type element according to another embodiment and the insulation components connected to it by the fixing means,

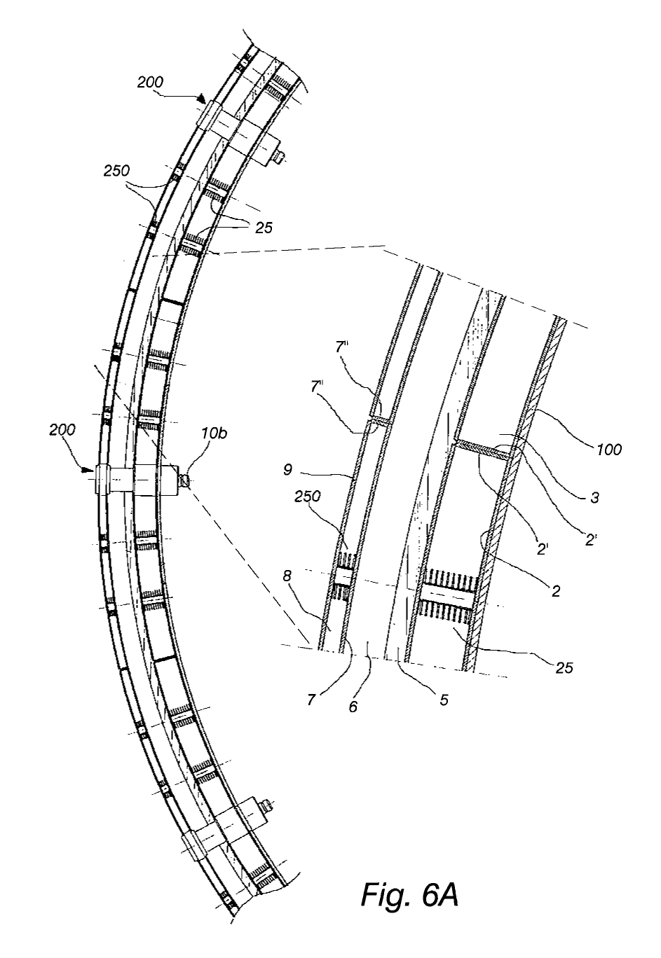

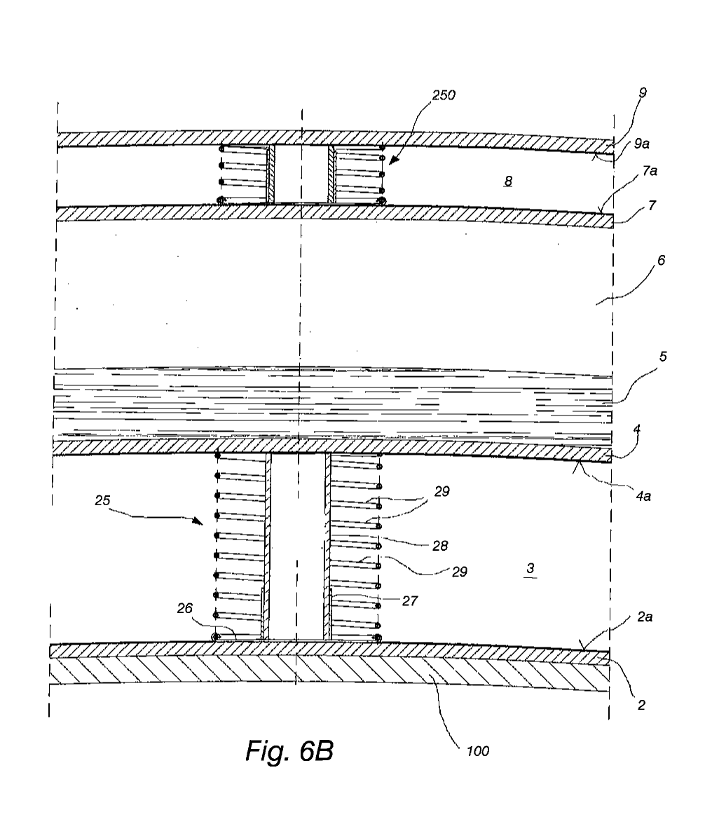

FIG. 6A shows a cross-sectional view of the intermediate supports arranged in the vacuum layers,

FIG. 6B shows the structure of the intermediate supports in greater detail,

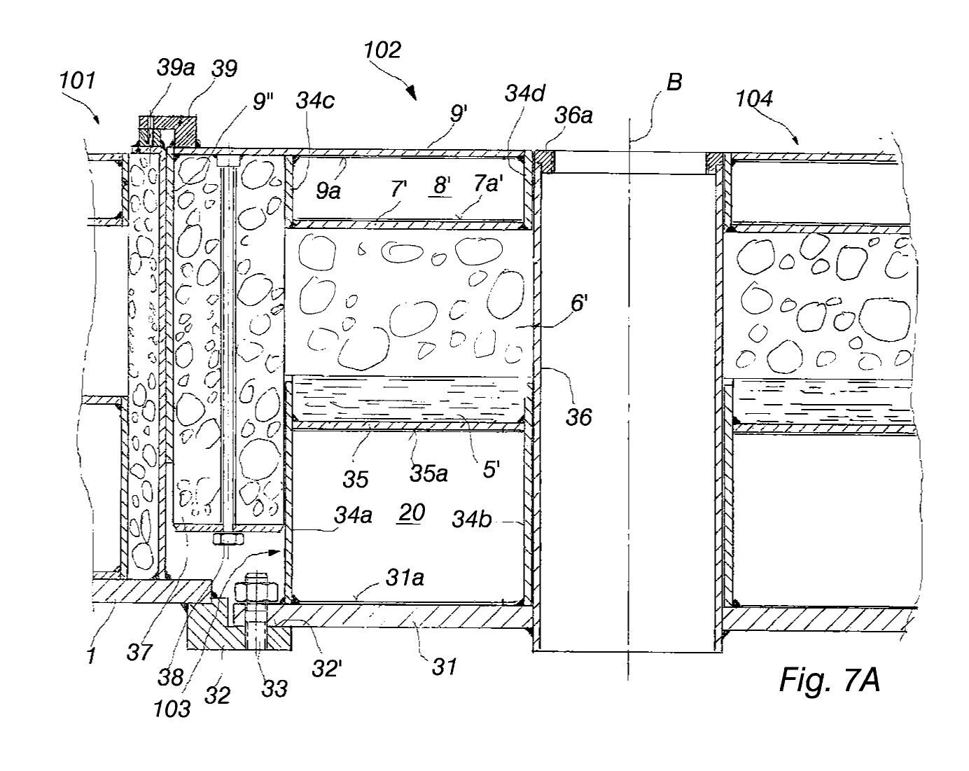

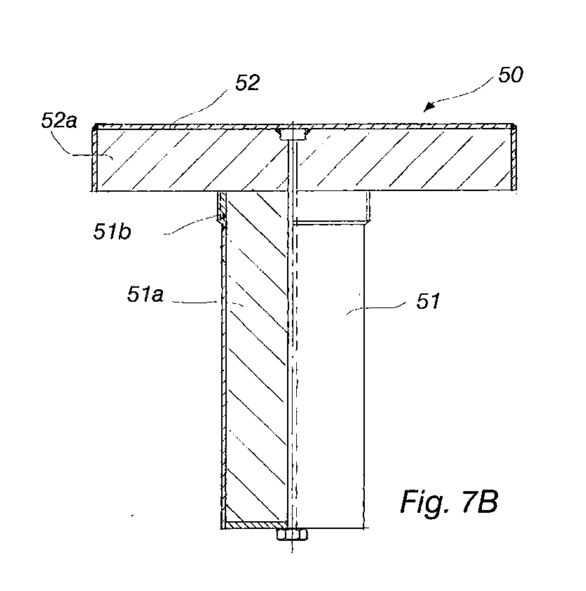

FIG. 7A shows the cross-section of an openable gate according to a preferred embodiment of the spherical object, which is provided with an insulation layer according to the invention,

FIG. 7B shows a stopper which closes the filler pipe of the openable gate of FIG. 7A,

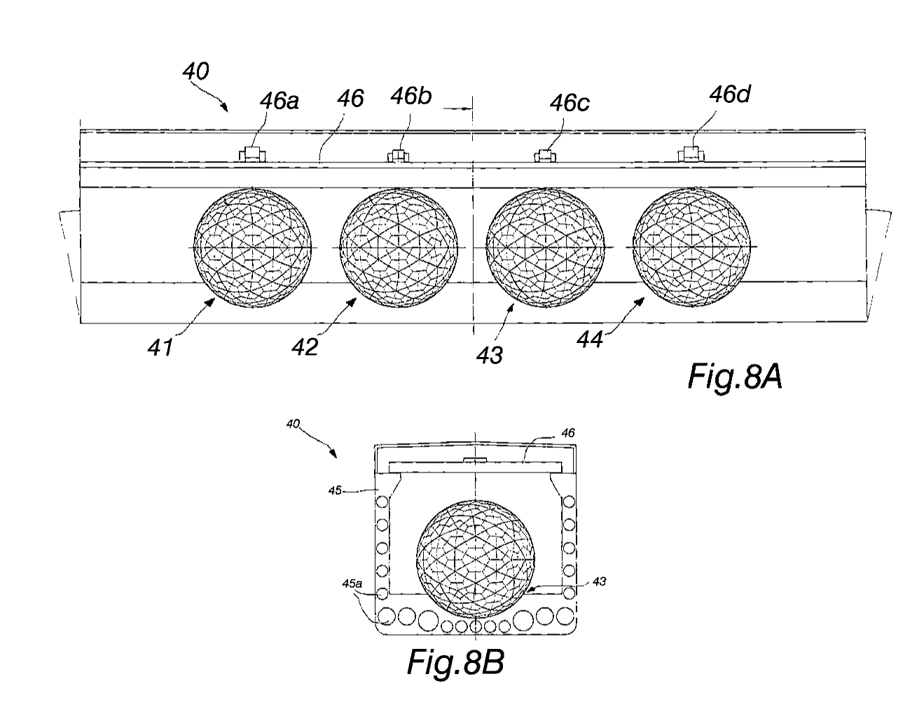

FIG. 8A shows a side view of a production line of insulated spherical objects according to a preferred embodiment,

FIG. 8B shows a cross-section of the production line of FIG. 8A,

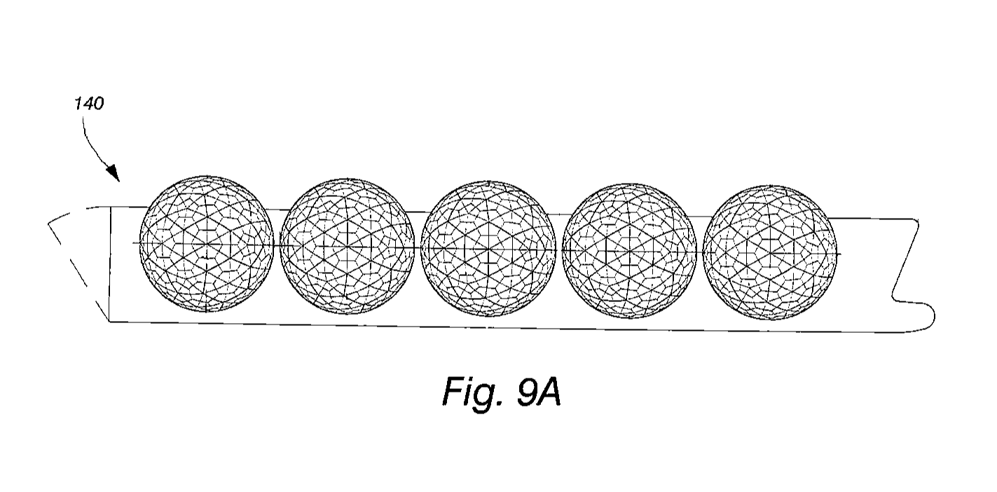

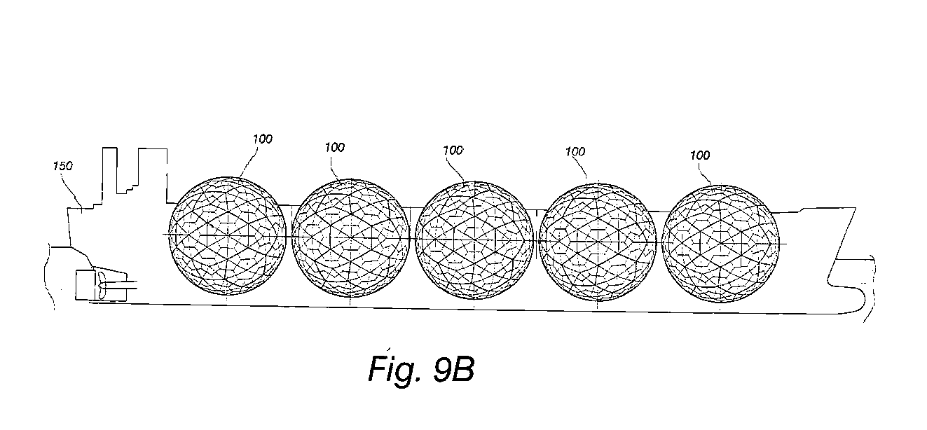

FIG. 9A shows a view in principle of a barge with spherical objects,

FIG. 9B shows a view in principle of a tanker provided with the spherical objects according to the invention,

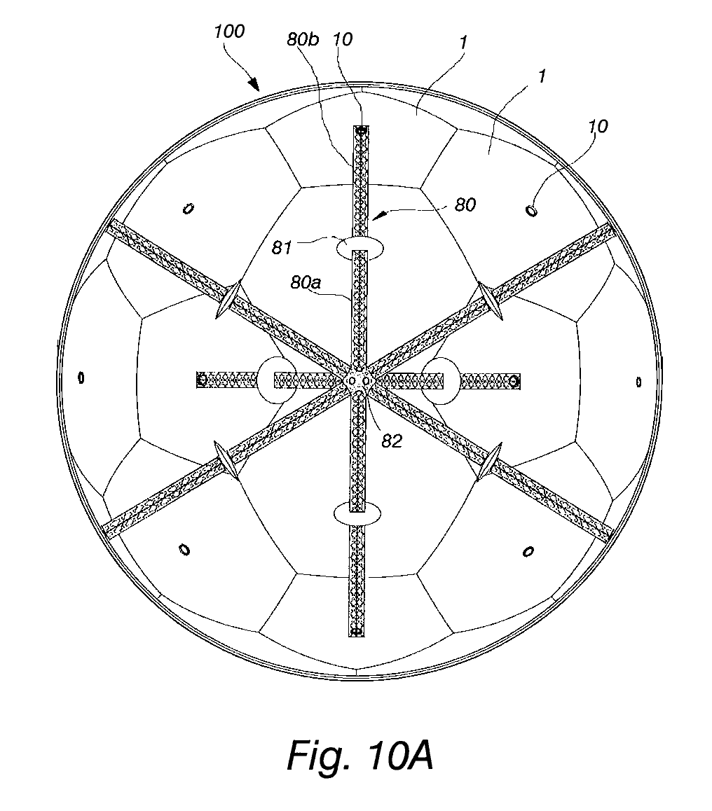

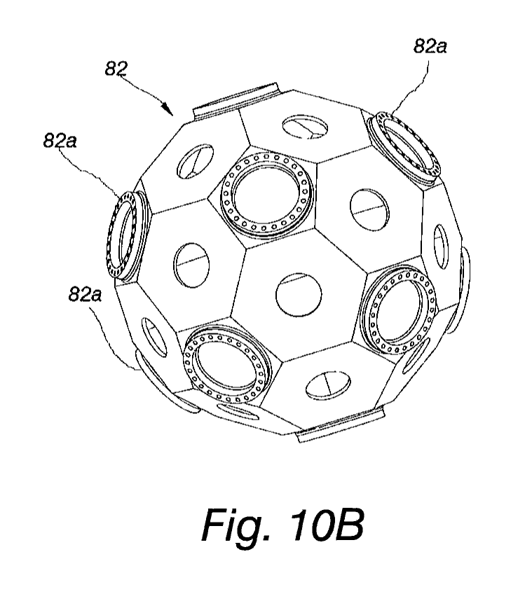

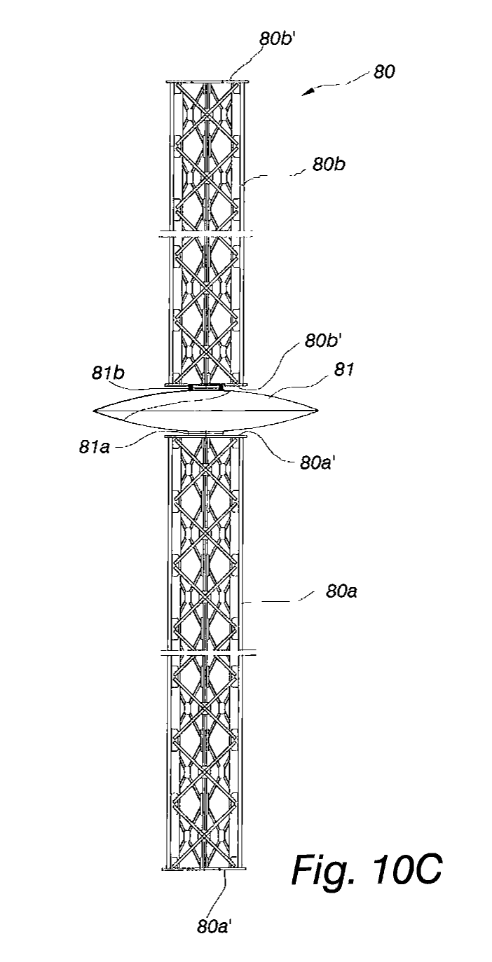

FIG. 10A shows a cross-section of the spherical object according to the invention which is provided with a support arrangement inside the spherical object,

FIG. 10B shows a smaller spherical object comprised in the support arrangement, and

FIG. 10C shows a support piece according to a preferred embodiment of the invention, which is fitted between the smaller spherical object and the spherical object.

First is described in general the basic structure of a completed spherical object, which is disclosed in greater detail in the Applicant's earlier application 20105520. Accordingly, FIG. 1 shows an example of a spherical object according to the invention, which is denoted by reference numeral 100, in conjunction with the outer surface of which is arranged the insulation according to the invention shown below. The spherical object 100 according to FIG. 1 is comprised of several joint parts 1. In this case, the parts 1 are hexagonal and pentagonal panel-type elements 1 and their relative positions are depicted in a plan view in FIG. 2.

In FIG. 2A, the hexagonal panel-type elements are identified more precisely with reference numerals HI, H2, H3, H4, . . . , H20 and the pentagonal panel-type elements are identified more precisely with reference numerals PI, P2, P3, . . . , P12. These identifications are here only for the purpose of clarifying the structure of the spherical object 100 in greater detail. In this case, the spherical object 100 comprises at least twenty pieces of hexagonal panel-type elements 1 and at least twelve pieces of pentagonal panel-type elements 1.

In addition to this, each panel-type element 1 has been formed with such a radius of curvature that when joined from their edges la, the panel-type elements 1 make up a hollow spherical object 100. The radius of curvature is preferably at least 0.75 metres and, depending on the application, the radius of curvature may in practice be determined to be as large as desired. At its largest, the radius R of such spherical object 100, for example the radius of the skin part of LNG containers (and of the transport containers of other liquid gases), is typically 10-50 metres. It is, of course, possible to fabricate spherical objects with an even larger radius. It should be noted that a preferred method for manufacturing a spherical object is disclosed in the Applicants earlier patent application FI 20105520, the teachings of which are incorporated in the present application.

Due to their large size, it is preferable to manufacture the panel-type elements 1 of extremely large spherical objects 100, such as those with a radius of 20 metres, of the panel segments shown in FIGS. 2B and 2C, or of similar smaller parts. In FIGS. 2B and 2C, the panel segments 1″ and 1″ and 1″″ are presented separately for the sake of clarity.

FIGS. 2B, 2E, 2F show hexagonal panel-type elements 1 comprised of panel segments 1′. It can be seen that all of the panel segments 1′ are identical. Panel segment 1′ is shown in greater detail in FIGS. 2G and 2H. It is thus advantageous that the hexagonal panel-type element 1 is made in the following manner. Six equilateral triangular pieces are first made. Each equilateral triangular piece is made of three square panel segments 1′ which are joined as shown in FIG. 2B. After this, the said equilateral triangular pieces, of which there are thus six, are joined, thereby forming a hexagonal panel-type element 1 (FIGS. 2E and 2F).

FIGS. 2C, 2I and 2J show pentagonal panel-type elements 1 made of panel segments 1″ and 1′″. It can be seen that there are two types of panel segments. The first of these panel segments 1″ are shown in FIGS. 2K and 2L. The second panel elements 1′″ are shown in drawings 2M and 2N. It is then advantageous that the pentagonal panel-type element 1 is formed in the following manner. Five equal-sided triangular pieces are first made. Each equal-sided triangular piece is comprised of two square first panel segments 1′″ and one square second panel segment 1′″, which are joined as shown in FIG. 2C. The said equal-sided triangular pieces, of which there are thus five, are then joined to form a pentagonal panel-type element 1.

The joining of the panel segments 1′ as well as 1″ and 1′″ preferably takes place by welding. The panel segments 1′ as well as 1″ and 1′″ are bent into shape before they are joined. FIG. 2D shows a completed spherical object 100 with a large radius, which is made of panel-type elements 1 made of the panel segments 1′ as well as 1″ and 1′″.

As material for the panel-type elements 1 is preferably used a metal or a metal alloy, such as steel, the material thickness of which varies depending on the application and the radius (diameter) of the completed spherical object 100. In typical applications, the material thickness varies within the range from 1.5 to 2.5 cm, but it may obviously deviate from this. It is, furthermore, advantageous that at least in applications in which the spherical object is in contact with water (the sea), the spherical object is coated, for example zinc-plated, both internally and externally.

Each panel-type element 1 of the spherical object 100 is provided with an attachment and handling cap, which is shown in partial cross-section in FIG. 4 and designated by reference numeral 10. The attachment and handling cap 10 is preferably in the centre of each panel-type element 1. The body of the attachment and handling cap 10 preferably has a cylindrical shape and it is preferably fixed by welding (weld joint W1) in a hole formed in the centre of a panel-type element 1. The fixed attachment and handling cap 10 is provided with counter-attachment means 10a, by means of which the vacuum components 110, 110a, 120, 120a and intermediate components 5 (and 6) described below can be fixed, by means of the fixing means 200, especially in conjunction with the corresponding panel-type element 1 (hexagonal or pentagonal) of the spherical object 100. The counter-attachment means 10a is preferably an inner thread formed on the cylindrical body, the central axis A of which is directed in the radial direction of the spherical object 100 essentially towards the centre of the spherical object 100. A preferred embodiment of the vacuum components 110, 110a, 120, 120a and the intermediate components 5 and their fixing means 200 is described in greater detail in the following, with reference to the accompanying drawings 3A to 6B.

FIGS. 4, 5, 6A and 6B show the locations of the vacuum components 110, 110a, 120, 120a and the intermediate components 5 and 6 arranged on the surface of the spherical component 100 with respect to one another and especially to the surface of the spherical component 100. The vacuum components include the first vacuum components 110, 110a arranged around the spherical object 100 and they are shown in FIGS. 3A, 3B, 3C and 3D. Positioned adjacent to one another on the surface of the spherical object 100, they form an inner vacuum layer 110′ (which can be seen in FIGS. 4 and 6A). The vacuum components also include second vacuum components 120, 120a, which are shown in FIGS. 3E, 3F, 3G and 3H. They form an outer vacuum layer 120′ (which can be seen in FIGS. 4 and 6A). From FIGS. 3A-3H can be seen that the outer edges of the vacuum components are hexagonal and pentagonal. These shapes correspond to the hexagonal and pentagonal panel-type elements 1 of the spherical object.

The first vacuum components 110, 110a, in other words the inner vacuum layer 110′, and the second vacuum components 120, 120a, in other words the outer vacuum layer 120′, are arranged at a distance from one another in the radial direction of the spherical object 100. Thus, between the inner layer 110′ and the outer layer 120′ are arranged intermediate components 5 made of at least one insulating material. The intermediate components 5 form an intermediate layer 5′ between the inner layer 110′ and the outer layer 120′. The material of the intermediate components 5 is preferably a heat-insulating material.

In the case shown in FIGS. 4A and 6A, there are two insulation layers, which are in addition of different insulation materials. Thus, intermediate layer 5′ and second intermediate layer 6′ are arranged on top of one another in the radial direction of the spherical object 100. Of these, the material of the first intermediate layer 5′ is preferably mineral wool and the material of the second intermediate layer 6′ arranged on top of it is preferably polyurethane. As material, mineral wool is highly cold-resistant, and thus it is preferable to place it as the first intermediate layer 5′. Consequently, the vacuum components 110, 110a, 120 and 120a and intermediate components 5 and 6 fixed in place form a spherical sandwich structure surrounding the spherical object 100.

Each layer is preferably formed individually in such a way that all first vacuum components 110 are fixed onto the spherical object 100 first. On the first vacuum components 110 are then fixed all first intermediate components 5 and possibly second intermediate components 6. Finally, all second vacuum components 120 are fixed on the intermediate components 5 and 6.

FIG. 4 shows in greater detail, in partial cross-section, the vacuum components 110, 110a, 120, 120a, intermediate components 5 and 6 and fixing means 200 according to a preferred embodiment, by means of which can be implemented the fixing of the vacuum components 110, 110a, 120, 120a and the intermediate components 5 and 6, which are placed on top of one another (aligned in the circumferential direction of the spherical object), to the spherical object 100. FIG. 4 further shows in greater detail the layered construction of the insulation, which makes possible using a thinner insulation layer than before, especially in spherical liquid gas tanks. FIG. 5 shows fixing means 200′ according to another embodiment, which are particularly suitable as fixing means for spherical objects 100 with large radii. The structure of this is also explained in greater detail in the following.

One preferred structure of a single first vacuum component 110 or 110a (of which is formed the first layer around the spherical object) is as follows. The space 3 forming a single first vacuum component 110 is formed between two hexagonal (and respectively also pentagonal) plates made of metal, such as steel plate pieces 2 and 4, arranged at a distance from one another. The shapes of the steel plate pieces preferably correspond to the shape of the edges la of the panel-type elements 1, that is, their edges are hexagonal or pentagonal in shape, as shown in FIGS. 3A-3D. The steel plate pieces 2 and 4 are bent to the correct radius of curvature correlating with the spherical object and they are connected at their outer edges by means of edge plates 2′ (see 6A). The angle of inclination of the edge plates 2′ with respect to the steel plates 2 and 4 is such that the edge plates 2′ are parallel to the straight line passing through the centre of the spherical object 100. Consequently, the edge plates 2′ of adjacent vacuum components 110, 110a are supported against one another and are thus joined together precisely through the edge plates 2′ without a slot (see FIGS. 3B and 6A). The vacuum layer 3 is thus a closed space remaining inside the steel plates 2 and 4 and the edge plates 2′. As seen from above, in the centre of each first vacuum component 110, 110a is arranged a sleeve-like cap part 11 belonging to the fixing means 200. FIG. 5A shows cap part 11′, respectively. The cap part 11 (11′ in FIG. 5A) is welded to steel plate piece 2 (weld joint W2) and steel plate piece 4 (weld joint W3). The cap part 11 (110 determines the distance between the steel plate pieces 2 and 4, in other words the thickness of the vacuum layer 3 in the radial direction of the spherical object 100. Here, it is approximately 14 centimetres.

In a preferred embodiment of the invention, the inner surfaces of the steel plate pieces 2 and 4 have a mirroring surface quality. This is achieved, for example, by providing the said inner surfaces with thin aluminium plates 2a and 4a with a mirror surface, the thickness of which is approximately 1 millimetre.

In a preferred embodiment of the invention, between the steel plates 2 and 4 are fitted the intermediate supports 25 shown in FIGS. 6A and 6B. An individual intermediate support 25 comprises a support element 26 arranged on the first steel plate piece 2 or its mirror surface 2a. The support element 26 is comprised of a base plate to which is fixed a guide pipe 27 for the actual support pipe 28. In the support element 26 is arranged, in the radial direction of the spherical object 100, a support pipe 28 having a length extending over the entire vacuum layer 3 (in the perpendicular direction), at the other end of which is supported the second metal plate 4 and its mirror surface 4a. In this respect, the intermediate supports 25 thus also act as fasteners for the plates 2a and 4a forming the separate mirror surfaces. Around the support pipe 28 is further fitted coaxially a coil spring 29 which is supported by its ends on the metal plates 2 and 4 or on the plates 2a and 4a forming the mirror surface. The supports 25 receive the load caused by air pressure and maintain the thickness of the vacuum containers 110 the same as determined by the sleeve-like cap part. The number of supports 25 is selected in accordance with the thickness of the plates from which the first insulation components 110 are made, or the thickness of the metal plates can be selected in accordance with the number of supports 25. This type of structure is also flexible in that the structure tolerates well the stresses caused by the wide range of temperature variations in the structure. FIG. 6A shows more clearly in a sectional view the location of the intermediate supports on the scale of the whole spherical object.

The first vacuum elements 110 which form the vacuum layer 110′ described above are each fixed through a sleeve-like cap part 11 by means of a cap screw 13 passing in the axial direction of the cap part, the outer thread at the first end 13a of which screw can be taken to the inner thread 10a of the attachment and handling cap 10. Thus, the collar 13c (FIG. 4) of the cap screw 13 fixes at the same time the entire vacuum element 110 against the spherical object 100, especially against the panel-type element 1 of the vacuum element 110 located at the corresponding point. Similarly, in the fixing means 200′ shown in FIGS. 5A and 5B, a cylindrical, preferably thick-walled fixing piece 13′ is taken through the sleeve-like cap part 11′. In its wall are fitted circumferentially at equal distances cap screws 13′ on the edges of the cap part 11′, the outer thread at the first ends 13a′ of which can be taken in the axial direction of the fixing piece to the inner threads at the corresponding points on the attachment and handling cap 10, thus fixing the vacuum element 110 in place. The vacuum element 110 is provided with a hole (not shown), for example, a threaded hole provided with a valve, to which can be connected means for draining the space 3 empty preferably before mounting on the spherical object 100. It should be noted that it is obviously not possible to drain the space 3 (and space 8 disclosed later) completely empty (into a vacuum), but it is clear that despite its denomination, some air or other fluid substances, such as other gases, remain in the vacuum element. It is also conceivable to replace the air completely or partly with another fluid substance.

Furthermore, as an extension of the cap part 11 in the radial direction of the spherical object 100 is arranged a cap sleeve 14 (14′ in FIG. 5A). Around this are brought form-fitting (corresponding to the shape of the hexagonal and pentagonal shape of the vacuum container) insulating intermediate components 5 and 6, the first of which is thus mineral wool. In the centre of this intermediate component 5 is formed an opening through which the cap sleeve 14 is taken when mounting the intermediate component 5 in place. The second intermediate component 6 is polyurethane with a similar opening for mounting. The joint thickness of these layers is approximately 16 centimetres.

On top of the intermediate components 5 and 6 are fitted second vacuum components 120 and 120a, the general structure of which corresponds essentially to the first vacuum components 110 and 110a shown in FIGS. 3A and 3B. The second vacuum components 120 and 120a also preferably form a vacuum container. The space 8 constituting a single second vacuum component 120 is formed between two hexagonal (and correspondingly also pentagonal) steel plate pieces 7 and 9 arranged at a distance from one another. The steel plate pieces are bent into the correct radius of curvature correlating with the spherical object and they are joined at their outer edges with edge plates 7″ (see FIG. 6A). The angle of inclination of the edge plates 7″ is such that it is parallel to the straight line passing through the centre of the spherical object 100. Thus, the adjacent second insulation components 120, 120a are joined precisely through edge plates 7″ without a slot (see FIGS. 4 and 6A). The vacuum layer 8 is thus a closed space or container remaining inside the steel plates 7 and 9 and the edge pieces 7″.

As seen from above, in the centre of this container (second insulation component 120) is arranged a second sleeve-like cap part 16 belonging to the fixing means 200 of the insulation component. The cap part 16 is welded to steel plate piece 7 (weld joint W4) and steel plate piece 9 (weld joint W5). Similarly, FIG. 5A shows cap part 16′. The height of the cap part 16 (160 determines the distance between the steel plate pieces 7 and 9, in other words the thickness of the vacuum layer 8 in the radial direction of the spherical object 100. Here, it is approximately 5 centimetres.

In a preferred embodiment of the invention, the inner surfaces of the steel plate pieces 7 and 9 have a mirroring surface quality. This is achieved, for example, by providing the said inner surfaces with thin aluminium plates 7a and 9a with a mirror surface, the thickness of which is approximately 1 millimetre.

The second insulation components 120 and 120a are placed on the insulation layer 5 (6) in such a way that the edges of the second insulation components 120 and 120a are aligned with the edges of the insulation layer 5 and 6, and that the second cap part 16 (16′ in FIG. 5) is fitted as an extension of the cap sleeve 14. In FIG. 4, the second cap part 16 is provided with an embedding at the bottom 16a of which is an opening. Through the opening, a fixing screw 15, especially a first end 15a provided with an outer thread 15a, is taken through the cap sleeve 14 in conjunction with the cap screw 13, to the inner thread formed in the upper part 13b of the cap screw 13. The second end 15b of the fixing screw is formed into the shape of a hexagonal head and adapted to fit in the embedding. The second end 15b of the fixing screw 15 is provided with an inner thread 15c which functions in the same manner as the attachment and handling caps 10. Similarly, it is also advantageous to provide one cap part 16 with an inner thread 16b, which is formed on the edges of the embedding. Similarly, in the fixing means 200′ shown in FIG. 5, a cylindrical, preferably thick-walled second fixing piece 15′ is taken through the sleeve-like cap part 16′ as an axial extension of the first fixing piece 13′. In the wall of the second fixing piece 15′ are also fitted cap screws 15a circumferentially at equal distances on the edges of the cap part 1. The outer threads at their first ends 15a′ can be taken to the inner threads formed at the corresponding points in the upper edge area of the first fixing piece 13′.

In a preferred embodiment of the invention, between the steel plates 7 and 9 are fitted the intermediate supports 250 shown in FIGS. 6A and 6B. Their structure and functioning correspond otherwise to the above-mentioned intermediate supports 25, but their overall length is arranged to correspond to the distance between the steel plates 7 and 9 in the radial direction of the spherical object. Furthermore, it is preferable to fit the intermediate supports 250 in the radial direction of the spherical object, coaxially with the corresponding intermediate supports 25. The number of intermediate supports 25 and 250 effects the strength of the spherical object 100 and this property can be utilised for obtaining the desired strength for the spherical object and insulation.

It should in addition be noted that each steel plate 2, 4, 7 and 9 may be composed of smaller joint segments (not shown separately in the Figures) in the same way as the panel-type elements shown in FIGS. 2B and 2C.

In addition to this, it is advantageous to provide the spherical object 100 with at least one openable and closeable gate, which is provided with a corresponding gate insulation component 102 having a sandwich structure, as described above. One example of such gate is shown in FIGS. 7A and 7B, in which the gate is denoted by reference numeral 31. There are, however, preferably several gates for different purposes. Such purposes include a so-called manhole, which is large enough for a person to pass through into the spherical object, for example for carrying out maintenance procedures. Another purpose of the gate 31 is a loading and/or unloading hatch, through which necessary materials can be delivered inside or brought out of the spherical object.

In FIG. 7A, the gate 31 is supported by its edges on a preferably circular collar 32 welded on edge of the opening in the panel-type element 1, specifically on a bearing ledge 32′ arranged on the collar 32. The bearing ledges 32′ of the collar 32 are over a distance inside the outer surface (the outer surface of the panel-type element 1) of the spherical object 100 in the radial direction of the spherical object 100 (the panel-type element 1). The above-mentioned distance is a distance equaling at least the material thickness of the gate, preferably a distance of 1.1 to 2 times the material thickness of the gate, thus leaving the gate 31 inside the outer surface of the spherical object 100 in the radial direction of the spherical object 100. On the edge of the gate 31 are provided preferably mechanical fixing means 33, such as bolts 33, by means of which the gate 31 is fixed removably to the collar 32. The gate 31 is preferably of the same material as the panel-type element 1 in conjunction with which it is provided. The bearing ledge 32′ of the collar is provided with a seal (not shown), which is arranged to circle alongside the opening of the collar 32 and to thereby provide a sealing between the edge of the gate 31 and the bearing ledge 32′ to prevent, for example, water from entering inside the spherical object 100 through the gate 31.

In the centre of the gate 31 is preferably arranged (by welding) a pipe 36, the lower end of which extends essentially to the level of the inner surface of the gate 31. The pipe 36 extends in the radial direction of the spherical object 100 essentially to the level of the outer surface of the insulation component provided on the gate 31. The other end of the pipe 36 is provided with a ring 36a with an inner thread, to which can be connected, for example, discharge or filling means not shown here.

A preferred embodiment of the insulation component 102 of the heat-insulated gate 31 is as follows. In connection with the gate 31 is provided a first vacuum element 103 of the gate 31, in which a space 20 is formed. For this purpose, to the gate 31 is fixed, preferably by welding on the gate 31, around the pipe 36, an annular container formed by an annular outer wall 34a and an inner wall 34b as well as a cover part 35. The diameter of the outer wall 34a is preferably smaller than the diameter of the gate 31 so that it is possible to provide the above-mentioned bolts 33 (or other mechanical fixing means) in the outer edge area of the gate 31. The surfaces remaining on the side of the cover part 35 and the space 20 of the gate 31 are preferably made with a mirror surface by providing them, for example, with aluminium plates with a mirror surface. Over the space 20 is fitted an annular first insulation component 5′ made of insulating material, which is preferably mineral wool. On top of this is further fitted an annular second insulation component 6′, which is preferably of polyethylene. On top of the insulation layers 5′ and 6′ is further fitted an annular second vacuum element 104, in which a second space 8′ is formed. The vacuum element 104 is comprised of an annular outer wall 34c, an inner wall 34d, and a base part T and a cover part 9′ arranged around the pipe 36. The outer edges of the cover part 9′ extend from the central axis B of the cover a distance further than the edges of the gate 31 and thus the circumferential outer wall 34c. The edges of the cover part 9′ are provided with a collar ring 39 through which are passed mechanical fixing means, such as screws 39a, for fixing the insulation component in place. On the edge of the cover part 9′ is in addition formed a bending part 9″, which is bent towards the surface of the spherical object 100. The bending part 9″ forms a cylindrical outer shell with the cover part 9′, the radius of the shell preferably being 1.1 to 1.3 times the radius of the cylindrical outer wall 34a. Thus, between the insulation components of the panel-type element 1 of the spherical object 100 and the insulation component 102 of the gate 31, under the cover part 9′, remains an annular space, through which the bolts 33 closing the gate 31 can be opened, if necessary. However, over its greatest distance in elevation, the above-mentioned space is provided with an insulating piece 37, preferably of polyurethane, fixed with bolts 38 to the cover part 9′.

The insulation component 30 of the cover 31 formed in this way can be opened in two parts. After opening the screw joints 39a of the cover part 9′, the cover part 9′, the bending part 9″, the vacuum container 8′ and the insulation component 37 fixed to the cover part 9′ with bolts 38 can be lifted first at the same time. After opening the bolts 33, the rest can be lifted from their place, that is, the cover 31, the vacuum container 20, the insulation layers 5′ and 6′ and the pipe 36.

When no filling or discharge means are attached to the thread 36a of the pipe 36, the pipe 36 insulating element 50 shown in FIG. 7B is connected to it. It is preferably an insulation cylinder 51a having a metallic cylinder shell 51, which can be taken into the pipe 36 so that sufficient insulation of the pipe 36 is provided. The attachment of the insulating element 50 to the pipe is here realised between the outer thread 51b of the upper part of the cylinder shell and the inner thread 36a provided in the upper part of the opening. The upper part of this insulation cylinder 51a is provided with a lid part 52, under the metal casing 52 of which is insulation material 52a, which is against the cover part 9″ of the space 8′, “covering” the area of the space 8′ below when the insulating element 50 is in place.

Manufacturing a spherical object according to the Applicant's earlier patent application FI 20105520 in a basin intended for it is highly advantageous. Since the unloaded weight of the large spherical objects (diameter 20-50 metres) is too great for moving with cranes, it is advantageous to provide the production line for fabricating spherical objects, for example, in a floating dock or a production line operating according to the floating dock principle, a view in principle of which is shown from the side in FIG. 8A and from the front in FIG. 8B. The production line is thus located in water, for example, in the sea, in close vicinity to the shore, or in a basin constructed for the purpose on the shore. The production line (floating dock) is designated by reference numeral 40 and it can be raised and lowered in a manner known as such, which is known in connection with floating docks.

In the floating dock 40 are arranged four of the above-mentioned basins 41, 42, 43, 44 in succession, each of which constitutes its own workplace in which spherical objects can be constructed and rotated on a fluid substance, such as water, by means of devices intended for this purpose. The production line 40 equipment also includes hoisting devices 46a, 46b, 46c, 46d, preferably four bridge cranes.

In the following is described an advantageous example of fabricating spherical objects provided with the vacuum components and insulation components according to the invention. The assembly of the spherical objects 100 is started at the first assembly station 41. There the spherical object is welded together from the inside and made waterproof, moved to the second assembly station 42 (basin 42), where the main welding (external welding) is carried out. The transfer to the second assembly station 42 takes place by lowering the production line (immersing downwards into water) in a manner known as such. The spherical object is then able to float and can be moved to the second assembly station 42 while floating. A bridge crane 46b positioned at a desired point above the basin, for example, by means of rails 46, positions the spherical object in precisely the correct position and location until the production line 40 is lifted from the water to working height. This is preferably the procedure for each transfer. At the third assembly station 43, the spherical object is finished, for example coated, painted, and preparations are made for starting the mounting of the vacuum components and insulation components and/or their mounting is partly carried out. At the fourth assembly station 44, the vacuum components and insulation components are mounted in the spherical object, or if some of the components have been mounted at the third assembly station 43, the rest of the vacuum components and insulation components are mounted and the finishing is carried out. In this way, the production flow on the production line 40 can be provided in such a way that there is a spherical object in the making at each assembly station. Therefore, with each immersion of the production line 40 is obtained a completed spherical object provided with the components and a new spherical object under work. That is, on the production line 40 according to the example there are continuously four spherical objects at different stages of manufacture. The number of assembly stations may vary depending on how many work stages are to be carried out at each workplace. It is, however, preferable to limit the number of workplaces to 1 to 8.

The completed, insulated spherical objects can be transported by sea or be positioned as such to the desired site in the sea by towing with a barge designed for the transportation (which carries, for example, five spherical objects), which can be immersed controllably. The barge 140 is shown in FIG. 9A. Thus, the spherical objects can be floated into position in the immersed barge 140. The attachment and handling caps of the spherical object or the attachment points (16b, 15c) formed in the fixing means 200, 200′ of the insulation components can then be utilised for fixing the spherical objects, for example, to a barge, to the support and attachment points constructed for it.

The attachment and handling caps of the insulated spherical object may further be utilised in the tankers 150 shown in FIG. 9B for transporting liquefied gases, such as LNG tankers. It is a considerable advantage that the tankers 150 can be manufactured at a different location and be provided with similar support and attachment points as the barges 140 described above. Thus, the spherical objects 100 manufactured at a different location and separate from the tanker 150 can be fixed by their support and attachment points (attachment points formed into the fixing means 200, 2000 to the above-mentioned support and attachment points of the tanker. At the same time, the spherical objects 100 reinforce the strength structure of the tanker 150. It must be possible to immerse the tanker 150 sufficiently for the duration of the installation of the spherical objects into place.

The spherical object 100 is preferably provided with an internal support arrangement of the spherical object 100. A preferred embodiment of such support arrangement is shown in FIGS. 10A, 10B and 10C.

In the cross-sectional view of the spherical object 100 shown in FIG. 10A is seen a general view of a flexible cross hatching boom construction. The construction is preferably comprised of a spherical object 82 located in the centre of the spherical object 100, which has a similar structure as spherical object 100. The spherical object 82 is shown in greater detail in FIG. 10B. Its diameter is, however, much smaller than that of the spherical object 100, as can be seen from FIG. 10A, preferably about 1/20 of the diameter of the spherical object. Between this spherical object 82 in the centre and the actual spherical object 100 is arranged a plurality of supporting arms 80.

The spherical object 82 in the centre is provided with attachment and handling caps 82a, the structure of which corresponds to the attachment and handling caps of the actual spherical object 100, in this case the attachment and handling cap 10 shown in FIG. 5. In connection with the spherical object 82, the attachment and handling caps 82a are, however turned onto the outer surface of the spherical object 82 in such a way that the central axis of each attachment and handling cap 82a of the spherical object 82 is coaxial with the corresponding attachment and handling cap 10 of the corresponding actual spherical object 100 in the radial direction of the spherical objects 100 and 82. The attachment and handling caps 82a are preferably located in conjunction with each pentagonal panel-type element 1 (if necessary, may even be located in conjunction with each panel-type element). They are thus also aligned with the attachment and handling caps 10 located in the corresponding pentagonal panel-type elements 1 of the spherical object 100.

FIG. 10C shows the structure of a single supporting arm 80. The supporting arm 80 preferably comprises two arm parts 80a and 80b, which are here cross hatching booms, and a flexible element 81 fitted between them.

The arm parts may have various structures, for example, O-beams or square beams. FIG. 10C shows a preferred cross hatching structured embodiment of the arm parts 80a and 80b. The structure of the arm parts 80a and 80b is here essentially similar to that of a cross hatching structured mast disclosed the Applicant's earlier Finnish patent application FI 20106374. Thus, the teaching of the patent application FI 20106374 regarding the structure of a cross hatching structured mast may be incorporated as such into this application as a part concerning the structure of the cross hatching structured arm parts 80a and 80b. Only the cross hatching structured arm parts have been adapted in dimensions to be applicable for use as parts of the support arms 80.

FIG. 10C also shows a flexible element 81 fixed between the arm parts 80a and 80b. The flexible element 81 is a disciform element which can be drained as empty as possible in the same way as the vacuum components 110, 110a, 120, 120a. The flexible element 81 is provided with attachment and handling caps 81a and 81b, the structure of which corresponds to the attachment and handling caps 10 of the actual spherical object 100.

Furthermore, the ends of the arm parts 80a and 80b are provided with collars 80a″ and 80b′ comprising the necessary equipment for connecting the arm parts 80a and 80b, for example, by means of screw joints to the attachment and handling caps 10 and 82a of the spherical objects 100, 82 and to the attachment and handling caps 81a and 81b of the flexible element 81, as shown in FIG. 10A.

An individual arm part 80 can be connected in place between the spherical objects 80 and 100 by shortening the length of the arm part 80. This is done by draining the flexible element 82 as empty as possible, whereupon the flexible element 82 collapses. Once the arm part 80 is in place, the necessary amount of fluid substance, such as air, water or oil is entered in the flexible element 80 to provide the desired supporting force. The internal pressure of the flexible element 82 can thus be adjusted hydraulically or pneumatically. It is thus also possible to utilise the flexible element 82 as a spring which dampens momentary load peaks exerted on the spherical object 100. This type of structure can be connected directly, for example by means of the attachment and handling caps 10 of the spherical object 100, in conjunction with the tanker, to be a part of the structure reinforcing the tanker 150 when the spherical object 100 is connected to the tanker 150 in the above-mentioned manner.

The present invention is not limited to the embodiments described, but may be applied in many ways within the scope of protection determined by the accompanying claims.

1-14. (canceled)

15. An insulated container, comprising:
a hollow spherical object that is an assembly of at least twenty hexagonal panel-type elements and at least twelve pentagonal panel-type elements, wherein each panel-type element has a radius of curvature such that when assembled the hollow spherical object has a radius of curvature of at least 0.75 meters, and each panel-type element including an attachment and handling cap;
an inner vacuum layer including a plurality of first vacuum components;
an outer vacuum layer including a plurality of second vacuum components, wherein the outer vacuum layer is disposed at a distance from the inner vacuum layer in a radial direction of the spherical object; and
an intermediate layer including a plurality of intermediate components, wherein the intermediately layer is disposed between the inner vacuum layer and the outer vacuum layer;
wherein the first vacuum components, the second vacuum components, and the intermediate components further include fixing means, and are fixed in place with respect to the hollow spherical object via the attachment and handling caps of the panel-type elements.

16. The insulated container of claim 15, wherein the intermediate components are made of heat-insulating material and the intermediate layer is an insulating layer.

17. The insulated container of claim 15, wherein the intermediate components are made of a flexible material, and the intermediate layer is configured to dampen and/or distribute forces external to the spherical object.

18. The insulated container of claim 15, further comprising a second intermediate layer including at least second intermediate components, wherein the second intermediate layer is disposed between the inner vacuum layer and the outer vacuum layer.

19. The insulated container of claim 15, wherein the first vacuum components are formed of steel plates and edge plates that define the space forming the first vacuum layer, and wherein the second vacuum components are formed of steel plates and edge plates that define the space forming the second vacuum layer.

20. The insulated container of claim 19, wherein each steel plate includes an inner surface that is a mirrored surface.

21. The insulated container of claim 15, wherein at least one panel-type element includes at least one openable and closeable gate disposed within an outer surface of the spherical object; wherein the openable and closeable gate includes a gate insulation component and a gate insulation fixing means configured such that the gate insulation component is fixed to the gate via the gate insulation fixing means.

22. The insulated container of claim 21, wherein the gate insulation component is surrounded by a plurality of insulation components, and further includes an insulation fixing means by which the gate insulation component can be fixed to the surrounding insulation components.

23. The insulated container of claim 15, wherein the intermediate components include a heat-insulating material.

24. The insulated container of claim 23, wherein the heat-insulating material is at least one of mineral wool and polyethylene.

25. The insulated container of claim 19, wherein each steel plate includes a plurality of smaller joint steel plate segments.

26. The insulated container of claim 15, wherein each panel-type element includes a plurality of joint panel segments.

27. The insulated container of claim 15, wherein the spherical object further includes an internal support system.

28. The insulated container of claim 27, wherein the internal support system includes cross hatching-structured supporting arms, each of which includes a flexible element by means of which a length of the supporting arm can be changed.

29. The insulated container of claim 15, where the spherical object is manufactured on a production line; wherein
the production line is provided in a floating dock, or is operated according to the floating dock principle;
the production line is located in the sea, or in the vicinity of the shore; and
the production line includes at least one assembly station comprising a basin for moving a spherical object under manufacture, or a completed spherical object, on a fluid substance.
